(19) United States
(12) Patent Application Publication
(10) Pub. No.: US 2005/0183896 A1
(43) Pub. Date: Aug. 25, 2005

(54) Omni-directional wheels and methods and vehicles employing same

(75) Inventors: Nicholas Fenelli, Trenton, NJ (US); Robert Mullowney, Hartboro, PA (US)

Correspondence Address: HALL, MYERS, VANDE SANDE & PEQUIGNOT, LLP, 10220 RIVER ROAD, SUITE 200, POTOMAC, MD, 20854, US

(73) Assignee: Airtrax, Inc.

(21) Appl. No.: 11/025,838

(22) Filed: Dec. 30, 2004

Related U.S. Application Data
(63) Continuation-in-part of application No. 09/827,173, filed on Apr. 6, 2001.
(63) Continuation-in-part of application No. 10/953,072, filed on Sep. 30, 2004.
(63) Continuation-in-part of application No. 10/647,122, filed on Aug. 25, 2003.
(60) Provisional application No. 60/197,391, filed on Apr. 14, 2000.
(60) Provisional application No. 60/506,723, filed on Sep. 30, 2003.
(60) Provisional application No. 60/633,704, filed on Dec. 6, 2004.
(60) Provisional application No. 60/633,703, filed on Dec. 6, 2004.

(51) Int. Cl. B60K 26/00

(52) U.S. Cl. 180/65.3; 180/7.1

(57) ABSTRACT

Omni-directional vehicles and wheels therefore including methods of constructing same. In alternative embodiments, omni-direction wheel modules for imparting omni-directional locomotional capabilities to vehicles and objects. In further alternative embodiments, apparatus and methods for transporting and loading and off-loading munitions utilizing specialized, omni-directional capable vehicles for improved efficiency and/or safety.

### RELATED APPLICATION DATA

This application is a continuation-in-part of U.S. patent application Ser. No. 09/827,173, filed Apr. 6, 2001, entitled HYBRID POWER SUPPLY MODULE, which claims the benefit of priority of U.S. patent application Ser. No. 60/197,391, filed Apr. 14, 2000, similarly titled; and is a continuation-in-part of U.S. patent application Ser. No. 10/953,072, filed Sep. 30, 2004, entitled VEHICLES AND CONTROL SYSTEMS THEREOF WITH ADJUSTABLE STEERING AXES, which claims the benefit of priority of U.S. patent application Ser. No. 60/506,723, filed Sep. 30, 2003, entitled VEHICLE WITH ADJUSTABLE STEERING AXIS; and is a continuation-in-part of U.S. patent application Ser. No. 10/647,122, filed Aug. 25, 2003, entitled RELOCATABLE OPERATOR STATION; and claims the benefit of priority of U.S. Provisional Patent Application No. 60/633,704, filed Dec. 6, 2004, entitled LOAD CARRYING VEHICLE AND EJECTION MECHANISM AND METHODS RELATED THERETO; and claims the benefit of priority of U.S. Provisional Patent Application No. 60/633,703, filed Dec. 6, 2004, entitled OMNIDIRECTIONAL WHEEL MODULES AND VEHICLES AND METHODS EMPLOYING SAME. Additionally, this application incorporates the entireties of the disclosures of U.S. Pat. Nos. 6,340,065; 6,394,203; 6,547,340; and 6,796,618 by reference.

### FIELD OF THE INVENTION

This invention relates to omni-directional wheels which are installable on vehicles to afford such vehicles with omni-directional locomoting capabilities. In further embodiments, this invention relates to apparatus and methods for transporting and loading and off-loading munitions utilizing specialized, omni-directional capable vehicles for improved efficiency and/or safety. In certain preferred embodiments, this invention further relates to omni-directional wheels for omni-directional vehicles that exhibit, alternately or in combination, constant ride height, low vibration, and/or reduced maximum ground contact pressure. In still further alternative preferred embodiments, this invention relates to omni-directional modules for adding omni-directional functionality to vehicles or objects.

### BACKGROUND OF THE INVENTION

Omni-directional vehicles capable of controlled motion in any direction have long been recognized as having many useful applications. In this regard, numerous designs of omni-directional vehicles and wheels therefore have been experimented with in various industries. Most heretofore known omni-directional vehicle designs are similar in that they use wheels that feature a number of rollers positioned about the periphery of the wheel with the rollers permitting the wheels to support motion in directions at angles to the wheel's plane of rotation (hereinafter, all uses of the words “roller” and “rollers” refer to the type of rollers used on or designed for omni-directional wheels for omni-directional vehicles). Omni-directional vehicles using such omni-directional wheels can move in any direction by rotating the wheels and rollers in various appropriate combinations. In such wheel designs, each omni-directional wheel's rotation is mechanically driven and servo controlled in a coordinated fashion to cause the vehicle to follow a desired path. A more detailed description of such a system and its mode of operation is disclosed in U.S. Pat. No. 4,598,782 issued to Ilon. In such a system, three, four, or more omni-directional wheels are connected to a suitable chassis, suspension, wheel drives, and controls to form an omni-directional vehicle.

Generally speaking, omni-directional wheels can be grouped into two classifications. The first class of wheels is comprised of a rigid hub that supports a number of free spinning rollers around its periphery. The hub, in turn, is rigidly coupled to an axle that, along with other omni-directional wheels and axles, supports the vehicle. The rollers are mounted at an oblique angle to the wheel's axle and are free to rotate about their own axles. Specific omni-directional wheel roller mounting angles have been specified such as in U.S. Pat. No. 3,789,947 issued to Blumrich which discloses the use of a ninety degree mounting angle. More specifically, the omni-directional wheel disclosed by Blumrich is disclosed as mechanically driven to produce motion parallel to the axis of rotation of the wheel. Additional omni-directional wheel designs which utilize ninety-degree roller mounting angles and free-spinning rollers are disclosed, for example, by Bradbury in U.S. Pat. No. 4,223,753; Hiscock in U.S. Pat. No. 4,335,899; Smith in U.S. Pat. No. 4,715,460; and Guile in U.S. Pat. Nos. D318,219 and D318,791. Conversely, omni-directional wheels with rollers mounted obliquely at roller mounting angles of approximately forty-five degrees with respect to the wheel shaft have been disclosed by Ilon in U.S. Pat. No. 3,876,255 and Amico in U.S. Pat. No. 5,701,966. U.S. Pat. Nos. 3,876,255 and 5,701,966 are hereby incorporated by reference in their entirety.

The second class of omni-directional wheels differ from the above described omni-directional wheel designs in that the rotational axes of the free spinning rollers intersect with the wheel's axis of rotation. Wheels of this class have been disclosed by Bradbury in U.S. Pat. No. 4,223,753, and by Pin, et al, in U.S. Pat. No. 5,374,879. In wheels of this class, two or more spherical rollers are mounted in fixed positions so as to constrain the vehicle's motion in the direction of wheel rotation, while being unconstrained in a direction that is orthogonal to the wheel's axis.

In known classes of omni-directional wheels, the axle supporting each roller may be mounted to the omni-directional wheel hub at both ends of the roller, as disclosed by Blumrich, in the center, as disclosed by Ilon and Amico, or at intermediate locations, as disclosed by Smith. Moreover, typical prior art omni-directional wheel rollers are coated with an elastomer surface contact material to improve traction, as disclosed by Blumrich, Ilon and Smith.

As can be surmised, the ability to move in any direction or to rotate within the perimeter (e.g. footprint) of a vehicle is advantageous for virtually any conceivable industrial or commercial vehicle that must be maneuvered within confined spaces (e.g. warehouses) or with particular precision. In this regard, a non-exhaustive list of vehicle types which are particularly improved by the utilization of omni-directional technology includes forklifts, scissorlifts, aircraft support and maintenance platforms, munitions handling vehicles, cranes, motorized dollies, delivery trucks, and wheelchairs.

Despite the known commercial need for omni-directional vehicles, initial omni-directional technologies did not achieve widespread commercial success due in part to the vibration and uneven ride produced by early omni-directional wheel designs. However, various improvements in omni-directional wheel designs have been made in recent years and are exemplified by the disclosures of U.S. Pat. Nos. 6,340,065 and 6,547,340 owned by Airtrax, Inc. In particular, the improvements in omni-directional wheel technologies that have been made by Airtrax, Inc. have vastly improved their commercial viability. Such commercial usefulness has been principally improved by designing an omni-directional wheel which exhibits constant compliance while rotating under load. When such a wheel design is employed on a vehicle, the vehicle exhibits substantially constant ride height during directional operation thereby reducing vehicle vibration and allowing higher safe operational speeds. Other improvements in omni-directional wheels made by Airtrax, Inc. have increased the load carrying capacity of the wheels.

Although, as aforesaid, the commercial viability of omni-directional wheels has been improved dramatically by various relatively recent Airtrax, Inc. innovations, the actual implementation of omni-directional wheels, much like the implementation of any major structural improvement in a given technology, can require substantial time and effort. In particular, using prior art technology and techniques in order to install omni-directional wheels on a conventional vehicle (e.g. an aircraft maintenance vehicle or a munitions handler) conventionally requires making substantial structural and or design changes to the vehicle itself. Such changes require considerable mechanical and/or engineering skill as well as significant labor times and/or costs.

Taking into account such problems in the art related to vehicle conversion, it would be beneficial to reduce the time and labor costs of converting vehicles to include omni-directional capabilities. Furthermore, it would be cost effective to reduce the amount of skilled labor required to convert such a vehicle (e.g. because skilled labor typically receives higher wages). At least one of the embodiments of the inventions disclosed herein is believed to address such needs.

In addition to the problems related to early iterations of omni-directional technologies in general, drawbacks and/or problems associated with the field use of specific industrial-type load handling equipment have been addressed herein as well.

In this regard, heretofore, various munitions handling equipment has been developed for loading and unloading munitions, armaments, and other payloads onto and off of military aircraft. Such systems conventionally comprise a trailer-type apparatus that is towable behind a truck or tractor and/or can also be hand-trucked.

In a typical transport and loading operation, using such prior art trailer-type equipment, a munition is first loaded onto the carrier platform of the apparatus, and then the munitions carrier apparatus is transported to an aircraft (e.g. on an aircraft carrier) either via manpower or by towing with a motorized vehicle. Thereafter, the apparatus is manually positioned so that the munition can be elevated into an aircraft loading position (so that the munition can be mounted to the aircraft).

Although, over the years, prior art munitions handling equipment has been used with varying degrees of success for transporting, loading, and unloading munitions cargo, there are various unresolved drawbacks in the art related to the maneuverability of conventional munitions handling vehicles as well as their mechanisms for disposing of or offloading “hot” munitions. For example, prior art military munitions handling protocols for aircraft carriers necessitate extensive resource waste as well as high costs related to munitions handling. In this regard, employing current military protocols, once a “hot” munition is identified, rather than simply removing the munition from the munitions carrier vehicle, current Navy aircraft carrier guidelines call for disposing the munition and the carrier vehicle by pushing the vehicle overboard e.g. into the ocean.

To affect this purpose, modern Navy aircraft carriers are equipped with disposal ramps via which conventional munitions carrying vehicles and their munitions are disposed of into the ocean. Specifically such ramps have a disposal opening near the perimeter of the deck of the ship having a ramp which extends downwardly and tapers or narrows into a “throat” area having a uniform width. The throat passage, in turn, opens to the surrounding water body.

In order to dispose of a munition, then, the vehicle carrying the unwanted munition is simply pushed to the disposal ramp and down through the disposal opening. Because the vehicle dimensions are smaller than the narrowest part of the disposal ramp (e.g. the throat), the entire munitions vehicle, including its cargo, falls to the ocean surface. As can be seen, therefore, each time a munition is disposed of, the munitions carrying vehicle must be replaced. This results in high use costs, requires that significant vehicle inventory and thus storage space be available, and results in wasted resources and/or unnecessary pollution. However, until now, other mechanisms or methods of disposing munitions have been unsafe or otherwise unsatisfactory.

In addition to the above drawbacks in the art related to resource waste and high cost of operation, known munitions vehicles are believed to be inadequately maneuverable for their intended purpose. For example, extremely accurate positioning is required in order to situate a munition in preparation for mounting it to an aircraft. In this regard, conventional vehicles typically employed for loading munitions are of the dual-axle-type and exhibit limited maneuverability in most directions e.g. in order to turn such a vehicle, the vehicle must also be moved either in forward or reverse (or, for some turn types, in both forward and reverse). Because the inefficient maneuverability of conventional munitions vehicles slows munitions loading and unloading and/or requires considerable operator skill, it would be desirable to have a munitions vehicle which is equipped for optimized maneuverability.

For the foregoing reasons, Applicants herein have recognized the benefits of employing omni-directional technologies on munitions handling vehicles (and methods related thereto), and, in particular, have developed certain improvements on such technologies as they pertain to the shortcomings in the art discussed above.

In view of the above-enumerated drawbacks and/or problems related to load carrying and omni-directional vehicles in general, therefore, it is apparent that there exists a need in the art for apparatus and/or methods which solve and/or ameliorate at least one of the above drawbacks or problems. It is a purpose of this invention to fulfill this need in the art, as well as other needs which will become apparent to the skilled artisan once given the following disclosure.

### SUMMARY OF THE INVENTION

Generally speaking, this invention addresses the above described needs in the art by providing:
a munitions handling vehicle adapted for loading and unloading munitions on and from military aircraft, the munitions handling vehicle comprising:
(a) a vehicle chassis;
(b) a plurality of omni wheels mounted on respective wheel axles and cooperating to induce omni-directional movement of the vehicle;
(d) a munitions carrier supported by the vehicle chassis for carrying munition loads, the munitions carrier being movable upon actuation of a lift between a weapons-transport position and an aircraft-access position, such that:
i. in the weapons-transport position, the lift is sufficiently retracted adjacent the vehicle chassis to facilitate transport of weapons in the carrier to and from the aircraft; and
ii. in the aircraft-access position, the lift is sufficiently extended to enable precision loading and unloading of weapons in the aircraft without repositioning or reconfiguring the aircraft.

In further embodiments, there is provided:
a munitions handling vehicle adapted for loading and unloading weapons in military aircraft, the munitions handling vehicle comprising:
(a) a vehicle chassis;
(b) a plurality of wheel axles attached to the vehicle chassis;
(c) a plurality of omni wheels mounted on respective wheel axles and cooperating to induce omni-directional movement of the vehicle;
(d) a mechanical lift supported by the vehicle chassis; and
(e) a munitions carrier secured to a top end of the lift, and comprising an elongated trough adapted for holding weapons in a generally prone position, the munitions carrier being movable upon actuation of the lift between a weapons-transport position and an aircraft-access position, such that:
   i. in the weapons-transport position, the lift is sufficiently retracted adjacent the vehicle chassis to facilitate transport of weapons in the carrier to and from the aircraft; and
   ii. in the aircraft-access position, the lift is sufficiently extended to enable precision loading and unloading of weapons in the aircraft without repositioning or reconfiguring the aircraft.

In alternative embodiments, there is provided: a munitions handling vehicle, as above, wherein each of the omni wheels comprises a plurality of generally elliptical-shaped rollers; and
alternatively, or in combination, a munitions handling vehicle, as above, wherein each of the omni wheels comprises at least six of the rollers; and
alternatively, or in combination, a munitions handling vehicle, as above, including an electric motor operatively connected to each of the omni wheels for actuating the wheels; and
alternatively, or in combination, a munitions handling vehicle, as above, wherein each electric motor comprises a minimum of 5 horsepower; and
alternatively, or in combination, a munitions handling vehicle, as above, wherein the mechanical lift comprises a scissor lift including a plurality of cooperating, interconnected, crossing arms; and
alternatively, or in combination, a munitions handling vehicle, as above, wherein the mechanical lift comprises a collapsible weapons stand including a plurality of cooperating, interconnected, folding arms; and
alternatively, or in combination, a munitions handling vehicle, as above, wherein the vehicle chassis comprises a support platform; and
alternatively, or in combination, a munitions handling vehicle, as above, wherein the vehicle defines a profile measured from an uppermost extremity of the vehicle to a ground surface, the profile being less than 14 inches when the mechanical lift is fully retracted; and
alternatively, or in combination, a munitions handling vehicle, as above, wherein the vehicle defines a maximum reach measured from the munitions carrier to a ground surface, the maximum reach being greater than 60 inches when the mechanical lift is fully extended.

In further preferred embodiments, there is provided:
a munitions handling vehicle adapted for loading and unloading weapons in military aircraft, the munitions handling vehicle comprising:
(a) a vehicle chassis;
(b) a plurality of wheel axles attached to the vehicle chassis;
(c) a plurality of omni wheels mounted on respective wheel axles and cooperating to induce omni-directional movement of the vehicle;
(d) a mechanical lift supported by the vehicle chassis; and
(e) a munitions carrier secured to a top end of the lift, and movable upon actuation of the lift between a weapons-transport position and an aircraft-access position, such that:
i. in the weapons-transport position, the lift is sufficiently retracted adjacent the vehicle chassis to facilitate transport of weapons in the carrier to and from the aircraft; and
ii. in the aircraft-access position, the lift is sufficiently extended to enable precision loading and unloading of weapons in the aircraft without repositioning or reconfiguring the aircraft; and
(f) the munitions handling vehicle defining a profile measured from an uppermost extremity of the vehicle to a ground surface, the profile being less than 14 inches when the mechanical lift is fully retracted.

In a further alternative embodiment, there is provided: a munitions handling vehicle adapted for loading and unloading weapons in military aircraft, the munitions handling vehicle comprising:
(a) a vehicle chassis;
(b) a plurality of wheel axles attached to the vehicle chassis;
(c) a plurality of omni wheels mounted on respective wheel axles and cooperating to induce omni-directional movement of the vehicle;
(d) a mechanical lift supported by the vehicle chassis; and
(e) a munitions carrier secured to a top end of the lift, and movable upon actuation of the lift between a weapons-transport position and an aircraft-access position, such that:
i. in the weapons-transport position, the lift is sufficiently retracted adjacent the vehicle chassis to facilitate transport of weapons in the carrier to and from the aircraft, and in the weapons-transport position, the vehicle defines a profile of less than 14 inches measured from an uppermost extremity of the vehicle to a ground surface; and
ii. in the aircraft-access position, the lift is sufficiently extended to enable precision loading and unloading of weapons in the aircraft without repositioning or reconfiguring the aircraft, and in the aircraft-access position, the vehicle defines a maximum reach of greater than 60 inches measured from the munitions carrier to the ground surface.

In yet additional embodiments, there is provided:
alternatively, or in combination with one or more of the embodiments described above, a munitions handling vehicle, as above, wherein each of the omni wheels comprises a plurality of generally elliptical-shaped rollers; and
alternatively, or in combination, a munitions handling vehicle, as above, wherein each of the omni wheels comprises at least six of the rollers; and
alternatively, or in combination, a munitions handling vehicle, as above, including an electric motor operatively connected to each of the omni wheels for actuating the wheels; and
alternatively, or in combination, a munitions handling vehicle, as above, wherein each electric motor comprises a minimum of 5 horsepower; and
alternatively, or in combination, a munitions handling vehicle, as above, wherein the mechanical lift comprises a scissor lift including a plurality of cooperating, interconnected, crossing arms; and
alternatively, or in combination, a munitions handling vehicle, as above, wherein the mechanical lift comprises a collapsible weapons stand including a plurality of cooperating, interconnected, folding arms; and
alternatively, or in combination, a munitions handling vehicle, as above, wherein the vehicle chassis comprises a support platform.

In still additional embodiments, there is provided: a method for loading weapons in military aircraft, comprising the steps of:
(a) transporting a weapon to an aircraft on a munitions handling vehicle, the vehicle comprising a plurality of omni wheels cooperating to induce omni-directional movement of the vehicle;
(b) with the vehicle located at the aircraft, moving the weapon from a weapons transport position, wherein the vehicle defines a profile of less than 14 inches measured from an uppermost extremity of the vehicle to a ground surface, to an aircraft-access position, wherein the vehicle defines a maximum reach of greater than 60 inches measured from the ground surface; and
(c) in the aircraft-access position, loading the weapon in the aircraft.

In certain further embodiments, such as useful for specific military applications (e.g. on Naval aircraft carriers), this invention fulfills the above described needs in the art by providing:
a load carrying vehicle comprising:
a vehicle frame;
wheels operationally connected to the vehicle;
a tray for carrying a cargo load, the tray being carried by a portion of the vehicle, the tray being selectively ejectable from the vehicle thereby to selectively eject cargo loads from the vehicle.

In further embodiments, this invention provides: a method of ejecting a munition from a munitions handling vehicle, the method comprising:
directing the vehicle to a ramp surface, the ramp surface having a initial width at an upper surface thereof, the ramp surface being declined towards a disposal area, and the ramp surface having a decreased width at a constriction thereof at a location located downwardly distant from the upper surface;
operating the vehicle carrying a munition to a location proximal the upper surface of the ramp such that gravity operates to locomote the vehicle downwardly on the ramp surface;
the vehicle having a plurality of wheels, each wheel having an axis of rotation;
the vehicle having a horizontal plane extending between the plurality of wheels' axes of rotation; and
the vehicle having a minimum width in the horizontal plane which is greater than the decreased width at the constriction of the ramp surface; and
wherein when the vehicle is locomoted downwardly on the ramp surface, the constriction obstructs the vehicle from travel beyond the decreased width area; and whereby thereafter the munition is ejected from the vehicle by operation of gravity thereon.

In at least one embodiment of the subject invention it is an object to provide a vehicle including an ejection actuation mechanism comprising a lever for selectively locking and unlocking the tray to the surface of the vehicle.

In an additional embodiment, it is an object to provide a vehicle wherein the lever comprises: a lever arm selectively moveable between a first lock position and a second eject position; wherein, in the lock position, the lever arm secures the tray to a portion of the vehicle; and wherein, when the lever arm is actuated to the eject position, a mechanism biases the tray into a roller engaging position such that the tray is movable to eject a load therefrom.

In an additional embodiment, it an object to provide a vehicle wherein the tray is in a roller engaged position, the tray is movable on a surface of the roller such that when the vehicle is oriented at an angle greater than a threshold angle, the tray will eject from the vehicle due to gravitational forces.

In an additional embodiment, it is an object to provide a vehicle wherein the vehicle includes a vehicle axis extending between a front and a rear portion of the vehicle; wherein, when the tray ejects from the vehicle, the tray ejects in a direction initially substantially in line with the vehicle axis.

In an additional embodiment, it is an object of the invention to provide a vehicle wherein when the lever arm is moved from the lock position to the eject position, a mechanism advances the tray a distance from the cargo carrying position into a eject position.

In an additional embodiment, it is an object of the invention to provide a vehicle, wherein when the tray is advanced the distance into the eject position, a surface of the tray is engaged to at least one roller such that the tray is movable along a surface via the roller thereby to eject a cargo load from the vehicle.

In yet a further embodiment, it is an object of the invention to provide a vehicle, wherein the vehicle is so designed such that cargo loads are ejected from the vehicle by ejecting the tray from the vehicle.

In still further embodiments, it is an object of the invention to provide a vehicle wherein the tray mount comprises a pair of tray mount rails located on a surface of the vehicle, the tray mount rails including a guide structure capable of guiding the tray as the tray is ejected from the vehicle.

In an even further embodiment, it is an object of the invention to provide a vehicle wherein the vehicle is motorized and the wheels of the vehicle enable omni-directional operation of the vehicle.

In an additional embodiment it is an object of the invention to provide a vehicle which further comprises:
at least one mount roller rotatably connected to the tray mount, the mount roller being so located on the tray mount such that the mount roller engages the tray when the lever arm is in the eject position; and
at least one tray roller rotatably connected to the tray, the tray roller being so located on the tray such that the tray roller engages the tray mount when the lever arm is in the eject position.

In an additional embodiment it is an object of the invention to provide a vehicle wherein the tray mount includes a mount rolling surface to which say tray roller is selectively engageable; and
wherein the tray includes a tray rolling surface to which the mount roller is selectively engageable.

In an additional embodiment, it is an object of the invention to provide a munitions carrying vehicle wherein the vehicle further includes:
a tray rolling surface located on a downward facing side of the tray;
a mount rolling surface located on an upward facing side of the tray mount; and
the mount roller being located proximal the front of the vehicle; and
wherein when the lever arm is located in the lock position, the mount roller is disengaged with the tray rolling surface and is located substantially forward of the tray, and the tray roller is disengaged from the mount rolling surface and is located substantially rearward of the mount rolling surface.

In still further embodiments, it is an object of the invention to provide a vehicle wherein the controller is connected to the vehicle with an operator boom structure comprising:
a first, a second, and a third arm;
the first arm connected to the vehicle via a first linkage, and the first arm connected between the first linkage and a second linkage;
the second arm connected between the second linkage and a third linkage; and
the third arm connected between the third linkage and the controller;
wherein the operator boom structure is so designed and so connected between the vehicle and the controller such that the operator boom structure enables a selected angular orientation of the controller to be maintained with respect to an angular orientation of the vehicle.

In one or more preferred embodiments of the invention, it is an object to equip vehicles, such as described herein, with omni-directional wheels that exhibit constant vehicle ride height, low wheel vibration, and high load capacity. In other embodiments it is an object to provide a design for rollers for omni-directional wheels that produces little or no wheel rotation-induced ride height fluctuation for an expected range of loading. In certain preferred embodiments, it is an object to provide low-vibration omni-directional wheels on forklift, scissor-lift and wheelchair vehicles. In still additional embodiments, it is an object to provide a method for designing omni-directional wheel rollers to provide low vibration performance when used on an omni-directional vehicle.

In some preferred embodiments, this invention improves the ride performance of omni-directional vehicles, reducing vibration and ride height variation, thereby eliminating a major impediment to widespread commercial application of omni-directional vehicles. For example, reducing the amount of vibration caused by the wheel of this invention enables omni-directional vehicles to operate at higher transit speeds. Additionally, in some embodiments, this invention increases the load capacity for omni-directional wheels so that an omni-directional vehicle can be modified to carry greater loads simply by replacing the rollers with rollers designed as herein disclosed. Also, in some embodiments, this invention reduces the peak average wheel footprint contact pressure and thereby permits omni-directional vehicles to operate on surfaces with lower compressive strengths.

In still further preferred embodiments, it is an object to provide omni-directional functionality to vehicles in a more cost effective and/or time efficient manner by providing:
an omni-directional wheel module comprising:
an omni-directional wheel having a hub;
an axle carrying the omni-directional so that the omni-directional wheel is capable of rotating about the axle;
a motor for powering rotation of the omni-directional wheel about the axle;
a transmission operatively interconnected between the motor and the omni-directional wheel; and
a brake for selectively inhibiting rotation of the omni-directional wheel; and
wherein the module components are assembled as a unitary, functional modular wheel assembly selectively installable and removable as an assembled unit.

In one embodiment, the omni-directional wheel employed by said module is so constructed such that a vehicle employing a plurality of such omni-directional wheels exhibits substantially constant ride height during directional operation.

In a preferred embodiment, the omni-directional wheel comprises:
a plurality of roller mounting brackets coupled to the hub; and
a plurality of rollers each rotatably coupled to at least one of the roller mounting brackets at a roller mounting angle, the rollers comprising;
a core rotatably coupled to the roller mounting bracket, the core having a first end and a second end; and
a contact surface of elastomeric material coupled to and radially disposed about the core with a volumetric shape such that the exterior profile of the contact surfaces of all the rollers forms a noncircular profile when viewed from a perspective laterally displaced from and coincident with the centerline of the hub.

In a further embodiment, therein is provided a vehicle comprising:
a vehicle frame;
a power storage device carried by the vehicle;
a plurality of omni-directional wheels operatively connected to the vehicle;
the power storage device being so connected to the motors of the plurality of omni-directional wheels such that the power storage device is capable of providing power to the motors to cause selective rotation of the plurality of omni-directional wheels.

In yet a further embodiment, there is provided:
a method of converting an object into an omni-directionally locomotable vehicle, the method comprising:
assembling a plurality of omni-directional wheel modules to the object.

In still a further preferred embodiment, therein is provided:
a method of converting a non-omni-directional vehicle into an omni-directional vehicle, the method comprising:
removing existing non-omni-directional wheels from a non-omni-directional wheeled vehicle;
connecting a plurality of omni-directional wheel modules to the vehicle to impart to the vehicle omni-directional functionality.

In still more preferred embodiments, there is provided:
a method of converting a non-omni-directional vehicle into an omni-directional vehicle, the method comprising:
connecting a plurality of omni-directional wheel modules to the vehicle to impart to the vehicle omni-directional functionality. In at least one form of this embodiment, the omni-directional vehicle retains at least one non-omni-directional wheel. In at least a second form of this embodiment, the non-omni-directional vehicle is a four-wheeled vehicle having four non-omni-directional wheels, and two of the non-omni-directional wheels are removed from the vehicle; and two of the non-omni-directional wheels are retained on the vehicle.

In an alternative embodiment, it is an object of the invention to provide a hybrid powered vehicle in which a reformer is located onboard the vehicle for providing fuel to a fuel cell. In at least one of such alternative embodiments, the reformer is capable of converting a fossil fuel, such as jet fuel, into hydrogen.

In yet a further alternative embodiment, additional omni-directional wheel modules are employed to increase the load carrying capacity of a vehicle. In one such example, six modules are employed. In another example, six omni-directional wheel modules are installed on a crane-type vehicle.

### BRIEF DESCRIPTION OF THE DRAWINGS

FIG. 1 illustrates a perspective view of a four wheeled omni-directional forklift vehicle equipped with omni-directional wheels comprised of six rollers which are center-supported and positioned with a roller mounting angle of forty-five degrees.

FIG. 2 illustrates an exploded view of an omni-directional wheel comprised of six center-supported rollers positioned about the hub with a roller mounting angle of forty-five degrees, showing hub, rollers, roller mounting structure and other structure for affixing the wheel to the vehicle.

FIG. 3 illustrates a profile view of an omni-directional wheel comprised of six center supported-rollers positioned with a roller mounting angle of forty-five degrees, showing how the rollers are shaped and positioned around the hub to form a circular profile.

FIG. 4 illustrates a sectional view of a roller for a omni-directional wheel showing roller structure and an embodiment that achieves low vibration operation by means of an exterior profile which deviates from shape that will give the omni-directional wheel a circular profile.

FIG. 5 illustrates a sectional view of a roller for an omni-directional wheel showing roller structure and an embodiment that achieves low vibration operation by means of grooves in the contact surface.

FIG. 6 illustrates a sectional view of a roller for an omni-directional wheel showing roller structure and an embodiment that achieves low vibration operation by means of zones in the contacting surface that have different coefficients of stiffness.

FIG. 7 illustrates a perspective view of an alternative omni-directional wheel with roller axles mounted at ninety degrees to the wheels axis of rotation and incorporating an embodiment that achieves low vibration operation by means of grooves in the contact surface.

FIGS. 8 and 9 illustrate alternate profile views of one embodiment of an omni-directional munitions handler according to the subject invention.

FIG. 10 illustrates a three-dimensional view of the embodiment of the omni-directional munitions handler depicted in FIGS. 8 and 9.

FIG. 11 illustrates a diagrammatic view of an omni-directional wheel module according to one embodiment of the subject invention.

FIG. 12 illustrates a schematic view of a vehicle control system according to one embodiment of the subject invention.

FIGS. 13A, 13B, and 13C illustrate alternate views (overhead, front-profile, and side-profile) of a tray mount, as part of an ejection system, according to one embodiment of the subject invention.

FIG. 14 illustrates an overhead view of a load ejection system according to one embodiment of the subject invention with certain parts shown in x-ray.

FIG. 15 illustrates a profile view of the load ejection system depicted in FIG. 14 with certain parts shown in x-ray.

### DETAILED DESCRIPTION OF THE INVENTION

For a more complete understanding of the present invention and advantages thereof, reference is now made to the following description of various illustrative and non-limiting embodiments thereof, taken in conjunction with the accompanying drawings in which like reference numbers indicate like features.

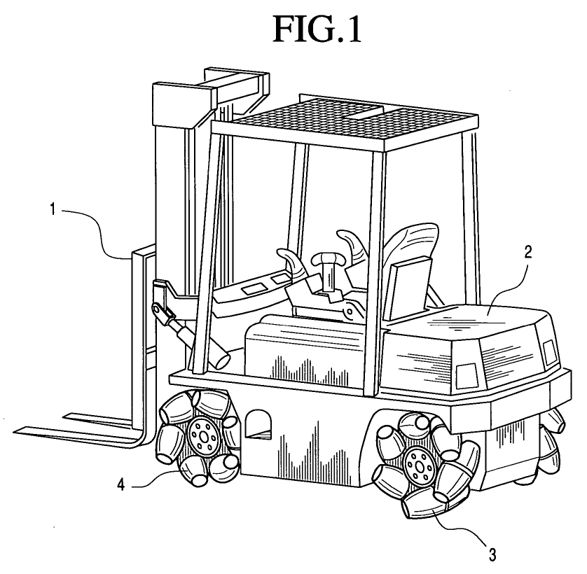

Referring initially to FIG. 1, a forklift-type vehicle employing a plurality of omni-directional wheels according to one embodiment of the subject invention is illustrated therein. As such, the depiction of such a forklift is primarily intended to illustrate one environment in which one or more embodiments of the invention find utility. In this regard, FIG. 1 is not intended to be limiting as many other vehicle types (or no vehicle at all) can be combined with the instant invention(s).

As illustrated in FIG. 1, forklift 1 is generally comprised of a vehicle chassis 2, three or more omni-directional wheels 3, wheel axles 4 which connect wheels 3 to chassis 2, and drive mechanisms (not shown) that rotate wheels 3 to cause the vehicle to move. A vehicle control system (not shown), such as that disclosed by Amico in U.S. Pat. No. 5,701,966, controls the drive mechanisms and coordinates the rotation of the wheels to cause simultaneous vehicle rotation and translation in longitudinal and transverse directions in response to operator commands.

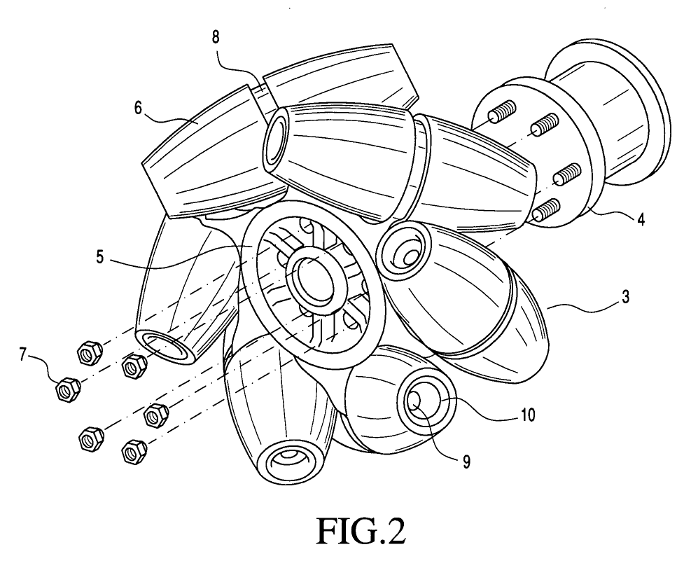

A primary factor in the operation of an omni-directional vehicle is the design of the omni-directional wheels. An exemplar omni-directional wheel according to one embodiment of the subject invention is shown in FIG. 2. Referring to FIG. 2, omni-directional wheel 3 is comprised of a hub 5 that supports a number of rollers 6 and is mounted to wheel axle 4 which, when installed, is coupled to a vehicle. Rollers 6 are coupled to hub 5 by roller mounting brackets 8 in fixed positions about the periphery of hub 5 so that roller axles 9 are at a fixed angle with respect to wheel axle 4. The acute angle formed by projecting the centerline of roller axle 9 onto the center line of wheel axle 4 is defined as the roller mounting angle. Omni-directional wheels may be designed with roller mounting angles of between approximately twenty degrees and ninety degrees, but roller mounting angles of approximately forty-five and ninety degrees are most commonly used in practice. The number of rollers 6 on an omni-directional wheel 3 is variable from preferably four (i.e. four being the current minimum number used), with six to eight rollers being most commonly used in practice. Rollers 6 have a flexible ground contacting material 10 typically made from an elastomer such as rubber or urethane. Omni-directional wheel roller ground contacting surface 10 has typically been designed with a convexedly vaulted exterior profile which is based upon the number of rollers mounted on the hub, the diameter of the omni-directional wheel, the roller center diameter, and the roller angle such that when the omni-directional wheel 3 turns, its contact with the ground shifts from roller to roller in a continuous fashion.

Prior descriptions of omni-directional wheels have emphasized the importance of designing the contour of the rollers as well as the importance of mounting the rollers about the hub so as to ensure their undeflected contact surfaces form an unbroken smooth circular profile when viewed from a perspective laterally displaced from and coincident with the centerline of the wheel. The roller profile that results in this smooth circular wheel profile is herein referred to as the “round profile.”

Moreover, prior descriptions of omni-directional vehicles have typically stressed that omni-directional wheels must be designed with roller ground contacting surfaces configured such that there is an unbroken arc from roller to roller so the wheel has a circular profile (i.e. round profile) when viewed side-on (e.g. along the axis of the axle). However, field use of such wheel designs has demonstrated that omni-directional wheels designed with such a circular periphery cause vehicle vibration and varying ride height when rotated while supporting a loaded vehicle. Vehicle vibration and ride-height variation result from the uneven compliance of the roller ground contacting surface over the profile of the roller. More specifically, since the thickness of the elastomer and diameter of a “round profile” roller varies along the length of the roller due to its convexedly vaulted profile, the amount of compliance exhibited under load varies as the ground contact patch shifts along the length of the roller as the wheel turns. As a result of this variation in roller compliance, omni-directional wheels designed according to previous descriptions exhibit apparent flat spots when operated under load, which produce an uneven vehicle ride. This invention eliminates or at least reduces the apparent flat spots by configuring rollers with a different profile, or varying the stiffness of the ground contacting material, or by a combination thereof, such that the effective profile of the omni-directional wheel under load is circular.

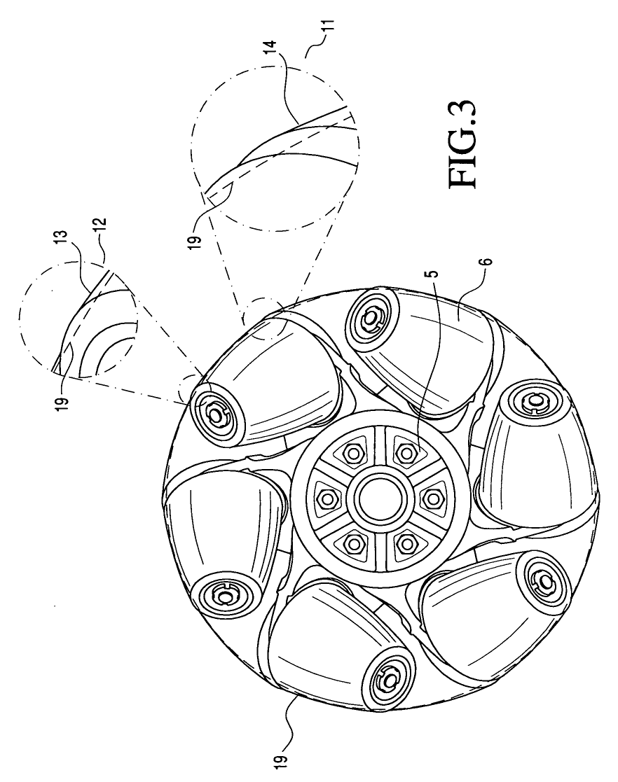

It is noteworthy that an omni-directional wheel using rollers incorporating an embodiment of this invention will have a noncircular profile, which contradicts the teachings of prior omni-directional wheel disclosures. An example noncircular wheel profile is shown in FIG. 3, which depicts an omni-directional wheel with six rollers set at a 45 degree angle to the wheel axle. Each roller 6 is mounted to hub 5 by means of a mounting bracket 8. A circular dashed line 19 is presented concentric with the wheel periphery, which shows the nominal radius of the wheel. A detail of roller end 12 clearly depicts the deviation of the roller surface at end 13 from the dashed line demarking round profile 19. A detail 11 of the roller adjacent to supporting bracket 8 clearly shows the deviation of roller surface 14 from the dashed line demarking round profile 19.

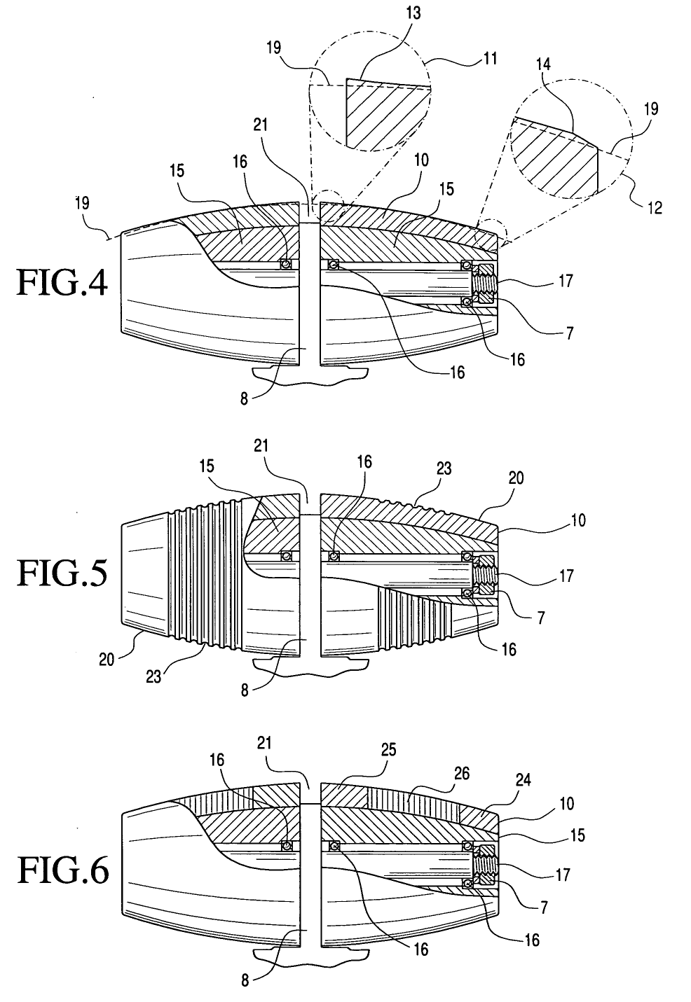

FIG. 4 shows a sectional view of a roller 6 and a portion of roller mounting bracket 8. As can be seen in the figure, roller 6 is a solid body of revolution comprised of a core 15 made of a metal or alloy thereof, a composite, a plastic, a ceramic or other suitable structural material or combination thereof, and a ground contacting surface 10 that is bonded, cast, welded, bolted, swaged or otherwise suitably coupled to core 15. Core 15 is rotatably coupled to roller mounting bracket 8 by one or more anti-friction bearings 16. A variety of anti-friction bearings may be used depending upon the configuration of roller 6, including ball bearings 16 as shown in FIG. 4. The roller is captured on the shaft by a threaded securing nut 7 or other suitable structure for attachment.

A variety of designs are possible for supporting core 15 on anti-friction bearings 16 and coupling the bearings to roller mounting bracket 8. FIG. 4 shows one configuration wherein roller axle 17 is welded or otherwise mechanically coupled to roller mounting bracket 8, and bearings 16 are mounted onto roller axle 17. Roller core 15 rides on bearings located axially so the roller is free to roll in either direction. Alternatively, the roller core can be rigidly coupled to or formed as a single unit with the roller axle, in which case the roller bearings are mounted between and coupled to the roller core and the roller mounting bracket.

As shown in FIG. 4, roller mounting bracket 8 may support roller axle 17 and core 15 near the midpoint between the two roller 6 ends. In such a configuration, roller 6 is comprised of two roller segments rotatably coupled to roller axle 17 and separated by a gap 21 where roller mounting bracket 8 attaches to roller axle 17. Alternatively, the roller mounting bracket can be designed to support roller core 15 or roller axle 17 at either end of roller 6. Additionally, there may be one, two, three, or more mounting brackets 8 supporting each roller 6, in which case, the roller will be comprised of a plurality of roller segments supported by either a common roller core or a common roller axle.

The roller contacting surface 10 is made of a flexible material that will deflect at the point of contact with the ground to spread the applied load onto a finite area on the ground. The ground contacting surface 10 may be made of an elastomer, such as urethane or natural rubber, which will have the added benefit of providing traction with the ground surface. The elastomer may be reinforced with fibers such as fiberglass and friction-enhanced with materials such as carbon black. Additionally, other materials may be used for higher load applications, such as glass filled nylon.

When an omni-directional wheel 3 supports the weight of a vehicle, the load is transmitted through axle 4 to hub 5, then through roller mounting bracket 8 to roller bearing 16 which transmits the load to roller core 15 and through it to one or more rollers 6 whose surface material 10 is in contact with the ground (i.e. where the load is applied to the ground).

In use, omni-directional vehicle 1 shown in FIG. 1 is capable of moving in any direction due to the interplay between rollers 6 and omni-directional wheels 3. As omni-directional wheel 3 is rotated, the roller 6, in contact with the ground, may turn about its shaft 17 in response to any torsional load. The rolling resistance in a direction normal to roller shaft 17 is small so that omni-directional wheel 3 is essentially free to move over the ground in a direction normal to roller shaft 17 and constrained from moving in a direction parallel to roller shaft 17. Rotation of omni-directional wheel 3 causes the point on roller 6 contact surface 10, in contact with the ground, to move from one end of roller 6 to the other until wheel 3 has turned enough so that the next roller in sequence about the periphery comes in contact with the ground and assumes the load. As the point of contact with the ground shifts along the length of roller 6, a force parallel to roller shaft 17 is imparted to hub 5, and through wheel axle 4 to vehicle 1 itself. Controlled omni-directional vehicle motion can be obtained by coordinated rotation of the wheels such as, for example, in a manner previously disclosed by Ilon in U.S. Pat. No. 3,746,112.

In the preferred embodiment of this invention shown in FIG. 4, the exterior profile of roller 6 contacting surface 10 deviates from “round profile” 19 depicted as a dotted line such that the roller has enlarged diameters near the roller ends 20 and gap 21. Specifically, roller 6 has added ground contacting surface material about roller ends 20 and adjacent to gap 21 to compensate for the increased compliance in those portions of roller 6. This is shown in details 11 and 12 where roller 6 surfaces 13 and 14 are not coincident with “round profile” 19 depicted as a dashed line. The additional material near roller ends 20 compensates for the increased compliance that results from the smaller diameter in that portion of the roller compared to the rest of the roller. The additional material near gap 21 compensates for the greater compliance that results from the reduced lateral support adjacent to gap 21. As a result of this improvement in roller design, when roller 6 contacts the ground under load, roller contacting surface 10 near roller ends 20 and adjacent to gap 21 deflects such that the wheel ride height does not change, which causes the omni-directional wheel to exhibit nearly constant ride height. As a result of the added material at roller ends 20 and adjacent to gap 21, the profile of roller 6 is different from the convexedly vaulted profile that has been taught in previous omni-directional wheel disclosures.

Referring now to FIG. 5, a second preferred embodiment of this invention achieves low vibration operation by varying the effective material stiffness of roller contacting surface 10 along the length of roller 6 through the use of grooves 23 in the surface in zones of lower compliance. Specifically, grooves 23 in roller contacting surface 10 serve to reduce the average stiffness of surface contacting material 10, and thereby increase the compliance of the surface in the zones containing grooves 23. As shown in FIG. 5, grooves 23 are located on roller 6 in the zone removed from roller ends 20 and gap 21. By selectively placing grooves 23 of the appropriate width, depth and spacing on roller contacting surface 10 in the zones where roller 6 has the lowest compliance (i.e. lowest amount of deflection under load), roller 6 can be designed to have near-constant deflection as the point of contact with the ground shifts along the length of the roller 6. Because a roller incorporating this embodiment undergoes consistent deflection of the contact surface as the ground contacting point shifts along the length of the roller, the distance between the ground and the wheel axle 4 remains nearly constant.

Grooves 23 may be oriented concentrically, longitudinally or angularly, or any combination thereof. Alternatively, the same stiffness-reducing effect can be achieved with stipling, dimples, ridges or knobs, and all discussions of and references to grooves herein also apply to stipling, dimples, ridges, and knobs. All combinations of groove orientations, stipling, dimples, ridges, and knobs are contemplated in this invention.

The depth, width and spacing of grooves each affect the effective material stiffness of the roller contacting surface 10. A roller design with constant compliance under load is achieved by selecting a combination of groove width, depth and spacing that, for the thickness and mechanical properties of roller contacting surface 10 material, roller diameter, and applied load, is necessary to match the compliance of the grooved portion with the compliance at roller ends 20 and adjacent to gap 21.

FIG. 5 shows a roller 6 with two zones on each roller segment 18; a zone with grooves 23, and zones with no grooves near roller ends 20 and adjacent to gap 21. In another variant of this embodiment of this invention, the average stiffness of roller contacting surface 10 can be designed to vary continuously across the surface by placing grooves at design-determined locations over the entire roller surface such that the spacing between each groove, and thus the average surface stiffness, decreases moving from roller end 20 to a minimum spacing near the roller segment midpoint, and then increases moving from the roller midpoint to the surface adjacent to gap 21. Such a roller would have few, shallow grooves near roller ends 20 and gap 21 that become progressively deeper, wider and more closely spaced toward the midpoint of the roller segment 18. A roller designed with appropriately varying groove dimensions would exhibit constant compliance under load and therefore would demonstrate even lower vibration in operation on a heavy load vehicle than would a roller with just two surface zones (i.e. a grooved zone and a not-grooved zone).

A roller 6 designed using only grooves 23 to achieve constant compliance along the length of the roller may have a convexedly vaulted shape with a “round profile” defined above. Thus, an omni-directional wheel incorporating this embodiment of the invention may present a round profile when viewed from a perspective laterally displaced from and coincident with the wheel's axle. This embodiment has the advantage that the wheel will exhibit a smooth ride when the vehicle is lightly loaded, in contrast to the first embodiment which, because of its deviation from the “round profile” defined above, will exhibit varying ride height when rotated while supporting very small loads.

It will be appreciated by one skilled in the art that the use of grooves will provide the same ride-enhancing benefits in roller designs comprised of one, two, three or more roller segments, where grooves are incorporated in some areas of some segments. Contemplated within the scope of this invention are all possible configurations and segmentations of rollers where grooves are used to adjust surface stiffness to achieve constant compliance across the entire roller.

It is noteworthy that the use of grooves in this invention is for purposes other than increasing traction which has been disclosed previously, although the grooves will have traction-improving effect. A roller using grooves designed only to improve traction without one of the embodiments of this invention will demonstrate varying compliance and thus vibration and ride height fluctuation in operation on a loaded vehicle.

Referring to FIG. 6, a third preferred embodiment of this invention achieves low vibration operation by varying the material stiffness of roller contacting surface 10 along the length of roller 6 by using different materials or formulations of elastomer. Specifically, in the zones near roller ends 24 and adjacent to gap 25, roller contacting surface 10 is made of a material with greater stiffness than the material in zone 26 near the midpoint of the roller segment. The greater stiffness of the material in the zone near roller end 24 compensates for the increased compliance that happens due to the smaller diameter of the roller ends. The greater stiffness of the material in the zone near roller gap 25 compensates for the increased compliance that happens due to the reduced structural support adjacent to gap 21.

The materials used in the various zones of the roller in this embodiment are selected to achieve nearly the same compliance as the point of contact with the ground moves along the length of the roller. Depending upon the shape, size and diameter of roller 6 and the width of gap 21, the material in roller end zone 24 may have the same or different stiffness as the material in gap-adjacent zone 25.

A roller 6 designed using different roller contacting surface material zones to achieve constant compliance along the length of the roller may have a convexedly vaulted shape with a “round profile” as defined above. Thus, a wheel incorporating this embodiment of the invention may present a “round profile” when viewed from a perspective laterally displaced from and coincident with the wheel's axle. This embodiment, like the second embodiment, has the advantage that the wheel will exhibit a smooth ride when the vehicle is lightly loaded, in contrast to the first embodiment that, because of its deviation from the “round profile” defined above, will exhibit varying ride height in operation when supporting very light loads.

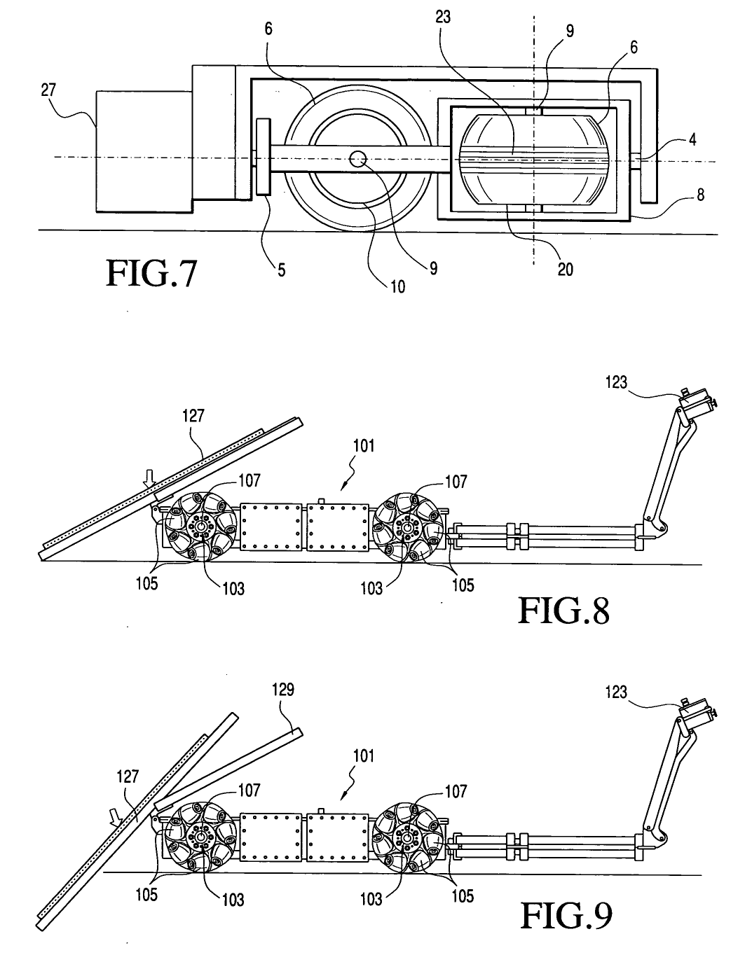

This invention benefits all omni-directional wheels that use a plurality of rollers on each wheel to enable motion in any direction. For example, FIG. 7 shows an omni-directional wheel incorporating a roller mounting angle of ninety degrees and two rollers 6. Hub 5 is connected to wheel axle 4, which is connected to a drive motor 27. A roller mounting bracket 8 is coupled to hub 5 and encircles rollers 6 so as to provide support for roller axles 9. The roller mounting bracket 8 may be formed from a single piece enclosing both rollers or may be two or more pieces coupled together. FIG. 7 shows rollers 6 incorporating grooves 23 to achieve constant compliance performance, but the rollers may incorporate any one or combination of the embodiments of this invention. In operation, when hub 5 is rotated by drive motor 27, the point of contact with the ground will shift over the surface of each roller 6 in turn. Since the ground contacting surface 10 near the ends of roller 20 is not continuous, roller 6 will exhibit greater compliance when the point of contact with the ground is near roller ends 20 than when the point of contact is midway between the ends. Thus, wheels of the design illustrated in FIG. 7 will suffer uneven compliance, and as a consequence high vibration when rotated while supporting a load, unless the rollers incorporate one or more of the embodiments of this invention.

It will be appreciated by one skilled in the art that the use of different material zones will provide the same ride-enhancing benefits in roller designs comprised of one, two, three or more roller segments, where different material zones are incorporated in some parts of some segments. Contemplated within the scope of this invention are all possible configurations and segmentations of rollers where different material zones are used to adjust contact surface material stiffness to achieve constant compliance across the entire roller.

Contemplated within the scope of this invention is the use of any combination of any or all of the three embodiments described herein to achieve constant compliance of the roller contact surface across the surface of the roller under a variety of design conditions. Depending upon various design parameters, such as vehicle weight, omni-directional wheel diameter, roller mounting angle, number of rollers, roller length, roller diameter, number of roller segments, roller gap thickness, surface contacting material and ground surface characteristics, it may not be practical to design a low-vibration omni-directional wheel that uses only one of the embodiments described herein. The use of a non “round profile” roller with grooving may have better overall ride and wear characteristics than is possible with one or the other embodiment alone. Using a combination of a non “round profile” design roller with zones of different roller contacting surface material could reduce vibration induced as the loaded area shifts from one material zone to the next.

The three exemplar embodiments of the invention have slightly different advantages. The first preferred embodiment is best suited for wheels that will be subjected to constant high loading which fluctuates between approximately 75 percent to 100 percent of rated load. The first embodiment also works best when the flat surface over which the omni-vehicle operates is somewhat sensitive to high contact pressures.

The second and third embodiments are best suited to vehicles that will carry varying loads. These embodiments will provide a smoother ride at vehicle loads that are a low percentages of the maximum rated load by virtue of the fact that the roller profiles match the “round profile” shape. Omni-directional wheels designed and constructed using the second and third embodiments of the invention will have higher contact pressures and greater percentage deflection, and thus somewhat reduced load capacity as compared with omni-directional wheels designed and constructed using the first embodiment of the invention. Rollers incorporating the first, second, and third embodiment of the invention are possible and may be the optimum design in some applications.

Using one or a combination of non “round profile” shape, grooving and different material zones in rollers for omni-directional wheels will result in a number of practical benefits. Smooth riding omni-directional wheels permit an omni-directional vehicle to travel at higher speeds without creating excessive vibration, and therefore broaden the applicability of omni-directional vehicle technology. The greater contact surface material thickness near the roller ends decreases the shearing force in the bond between the contact surface material and the roller core. Decreased shearing force in the contact-surface-material-to-core bond results in increased operational life of the roller. Rollers that display constant compliance across their profile may have a higher design load capacity, because the load capacity will not be limited by the capacity of the roller contacting surface material at the roller ends or adjacent to the roller gap. A roller with constant compliance under load will exhibit a nearly constant footprint in contact with the ground as the ground contact point moves along the roller length, which decreases the maximum footprint pressure of the roller compared to a roller designed in accordance with the prior art which will exhibit variable footprint pressure in operation. Lower maximum footprint pressure reduces roller wear, and thereby increases the useful life of the roller. Lower maximum footprint pressure also permits the omni-directional vehicle to carry heavier loads or operate on surfaces with lower compression strength, such as concrete, sheet metal or wood decking.

The appropriate design of any of the three preferred embodiments and any combination of any two or all three is achieved by determining the elastomer material thickness and properties necessary to achieve compliance that is nearly constant as the wheel is rotated under design loads. To accomplish this, the compliance of the roller is estimated for each increment of omni-directional wheel rotation as the load is supported first at the end, then the middle, and then the opposite end of the roller. This calculation must consider both the roller diameter at the point of contact with the ground and the angle between the ground and the roller axle, because the geometry of the roller's contact with the ground is constantly changing as the wheel rotates.

A mathematical relationship that describes the deflection of a prismatic elastomer coated roller in response to an applied loads has been known for some time. One variation of this relationship has been described by A. I. Hoodbhoy in Plastics Engineering, Vol. 32. No. 8, August 1976 and is repeated as equation (1) below:

Equation 1

Prismatic Elastomer Coated Wheel Deflection,
U=[3W(B−A)/(4ES(8B)^{1/2})]^{2/3}
Where:
W=Load;
B=Outside Diameter;
A=Inside Diameter;
E=Elastomer Modulus; and
S=Tire Width.

Equation (1) is applied in a unique manner in the present invention to accurately predict the compliance of an omni-directional wheel and its response to an applied load for any angle of rotation. Specifically, the roller is modeled as many narrow slices that are each treated as individual prismatic wheels with the elastomer thickness, properties and outer diameter corresponding to the particular slice of the roller. The number of slices used in the calculation can range from 100 to 150 for a single roller. As an example, a 13 inch long roller could be modeled with as few as 100 prismatic rollers 0.13 inches in thickness, or with as many as 150 prismatic rollers 0.87 inches in thickness. Each of the prismatic wheels that represent the roller are treated as being aligned concentrically along the roller shaft axis.

When an omni-directional wheel is rotated to such a point that the roller shaft is parallel to the ground surface, the thickness of the elastomer for each slice used to represent the roller matches the actual thickness of the roller. When the wheel is rotated further, the roller shaft will no longer be parallel to the ground surface, and the elastomer thickness measured at right angles to the roller shaft must be reduced by multiplying the thickness times the cosine of the angle between the roller axle and the ground surface. The angle that the roller axle makes with the ground surface is calculated using equation (2):

Equation 2
I=Arcsine[cosine (roller mounting angle)sine(wheel rotation angle)].

The roller mounting angle is typically 45 degrees but can range from about 20 to 90 degrees, and the wheel rotation angle varies from 0 to 360 degrees.

The vertical distance H from a plane through the wheel axis and parallel to the ground surface to the lowest point on any roller slice is calculated using equation (3):

Equation 3
H=Cosine(θ)[Ri+xi tangent(θ)]+RR cosine(wheel rotation angle)
where
θ=angle between roller shaft and ground surface;
Ri=exterior radius of roller at a distance xi from the roller mid point measured along the roller axle;
xi=distance from the mid point of the roller measured along the roller axle; and
RR=radius of the roller mid point from the wheel center.

The lowest point on the undeflected roller slice with the greatest vertical distance from a plane coincident with the wheel axis and parallel to the ground surface will always be in contact with the ground surface, even at very small loads. This vertical distance is the undeflected wheel diameter at that particular angle of wheel rotation. As the load is increased, the roller elastomer will deflect in response, and the plane coincident with the wheel's axis and parallel to the ground will move closer to the ground. This is modeled as bringing adjacent slices of the roller into contact with the ground surface. The deflection of adjacent roller slices will be smaller than the roller slice with the greatest vertical distance from a plane coincident with the wheel axis and parallel to the ground surface at that particular wheel rotation angle. In this way, a designer can determine the deflection of adjacent slices as a function of the roller geometry, wheel rotation angle, roller dimensions, and total wheel deflection.

For a given value of wheel deflection and rotation, the designer can estimate the load carried by each slice using equation (1). Summing these loads provides an estimate of the total load on the wheel to produce the value of wheel deflection. Repeating this calculation for a range of deflections will enable the load-to-deflection characteristics of the wheel to be plotted for any wheel rotation angle. Repeating these steps for many wheel rotation angles, such as in 5 degree increments, will provide data that characterizes the wheel's performance under load.

Wheel ride height can be estimated by subtracting the deflection from the undeflected wheel diameter described above. Wheel ride height will range from a maximum of the aforementioned undeflected wheel diameter to a value that will decrease with increasing load. This can be represented as a surface plotted with wheel rotation angle and applied load as independent variables and wheel ride height as a dependent variable. This method of analytically characterizing an omni-directional wheel's performance is well suited to spreadsheet computation.

A corollary product of the above omni-directional wheel ride height prediction is the estimation of the percent deflection of the elastomer. This is the ratio of the wheel deflection to the undeflected elastomer thickness at the point of contact with the ground. Values for percent deflection are readily predicted using the above described process. The omni-directional wheel designer may plot peak values of percent deflection as a function of loading and rotation angle. A maximum of 25% deflection should not be exceeded.

With these analysis methods a designer can design an omni-directional wheel and rollers to implement this invention as follows. First, select the roller size and diameter that is appropriate for the omni-directional wheel, vehicle and design load. Second, determine the best means to support the rollers, and design the appropriate mounting bracket, core, axle and bearing structure. Third, determine the maximum elastomer thickness that will afford adequate roller core and axle material thickness and cross section. Fourth, calculate the roller's ride height and percent of elastomer deflection using the multi-slice analysis method described above. Note where flat spots and elastomer deflection will exceed 25 percent. Fifth, add small amounts of elastomer to the outer diameter to bring flat spots in the ride height into conformity with the rest of the roller. Additions to the outer roller diameter beyond the “round profile” may be added where the roller contacts the ground surface at the wheel rotation angles where a flat spot occurs. Typically this will be around supports and near the roller ends which are of smaller diameter. Adding an amount to the roller outer diameter equal to twice the deviation of the flat spot from the desired ride height will bring the roller design close after only a few design iterations. Alternatively, change the stiffness of parts of the ground contacting material by adding grooved zones or zones of material with a different stiffness. Sixth, repeat the calculation of the wheel's ride height and percent elastomer deflection as a function of load and rotation angle after each alteration in the roller outer diameter profile. Finally, repeat this design process until satisfied that the wheel ride height fluctuation will be acceptably small and peak percent deflections are below the maximum allowable. If an elastomer deflection below 25 percent cannot be achieved at the desired load capacity, a larger wheel or a wheel with fewer rollers may be necessary. This design method may result in increases in the outer diameter and thickness of the elastomer within the ranges listed in the following table:

| | | RANGE |
|---|---|---|
| | RANGE IN | IN PERCENT |
| | PERCENT INCREASE | INCREASE IN |
| LOCATION | IN ELASTOMER | ROLLER OUTSIDE |
| ALONG | THICKNESS OVER | DIAMETER BEYOND |
| ROLLER AXIS | “ROUND PROFILE” | “ROUND PROFILE” |
| Near | 8-30 | 2-8 |
| Supports | | |
| Between | 3-25 | 1-7 |
| Supports | | |
| Extreme End | 5-36 | 1-11 |

Referring now to FIGS. 8 and 9, a unique munitions handling vehicle 101 having omni-directional functionality is illustrated therein. In this regard, the illustrated munitions handling vehicle solves one or more of the problems associated with such vehicles (e.g. as described in the Background section above) as they have been heretofore known in the art. The particular manners in which such problems are ameliorated is discussed more specifically in connection with the detailed description of vehicle 101 which follows below.

As illustrated, the vehicle depicted in these figures employs a plurality of omni-directional wheels 103 located substantially proximate the “four corners” of the vehicle body 105 to achieve omni-directional functionality. As described in more detail above with respect to the omni-directional wheel embodiments, each wheel 103 comprises a plurality of independently rotatable rollers 105 disposed radially about wheel axes 107. As such each roller can be mounted oriented, relative to axes 107, according to any of the principles delineated above, and, moreover, can be constructed of any suitable material or combination of materials in any configuration, such as described above, which is suitable for achieving omni-directional functionality.

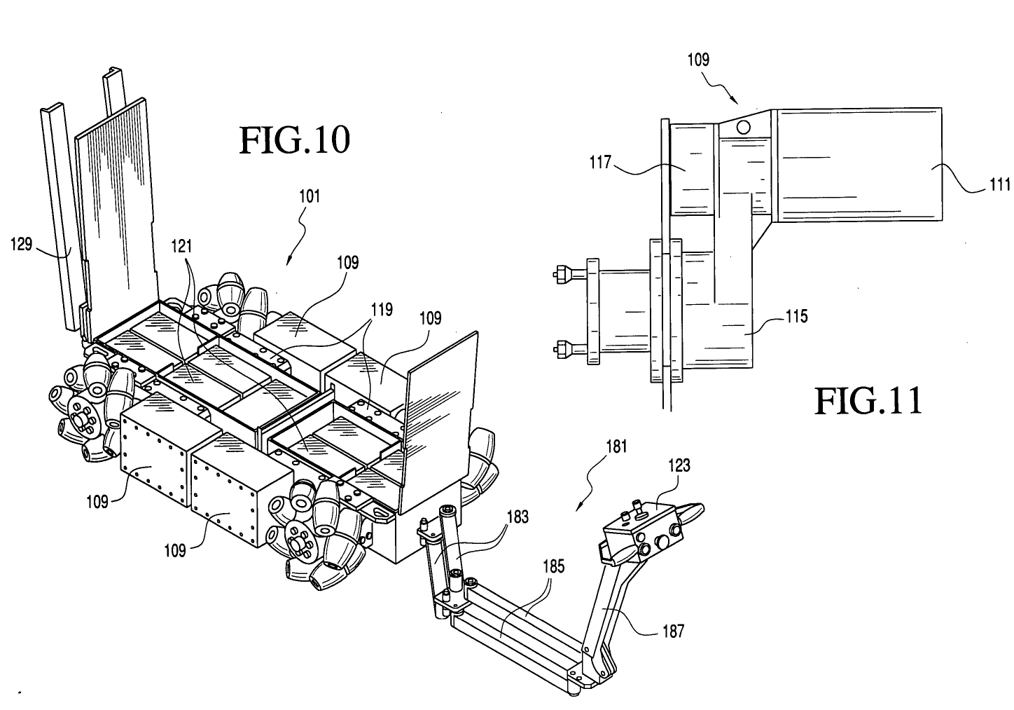

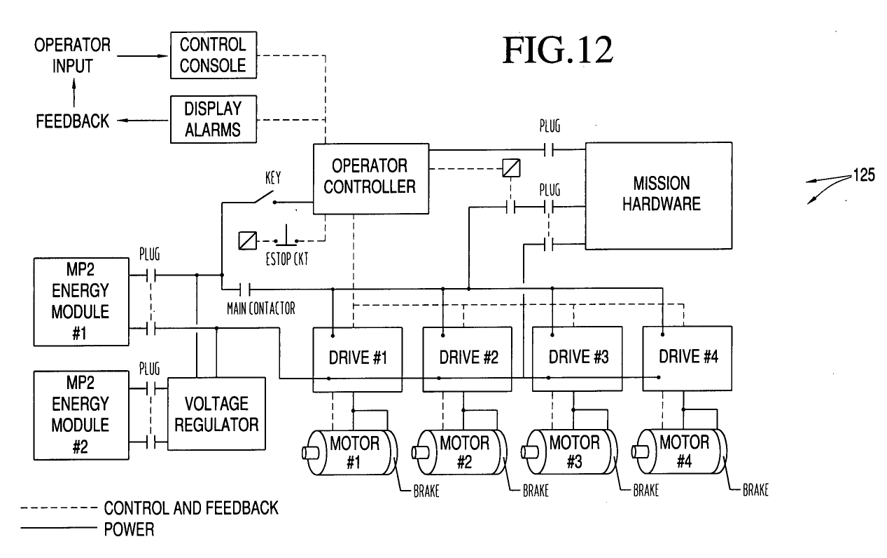

As can be seen more clearly in FIG. 10 and as represented diagrammatically in FIG. 11, in the illustrated embodiment of the invention, each omni-directional wheel 103 is assembled as part of a self-contained omni-directional wheel module 109. Each module 109, in turn, includes, in addition to an individual omni-directional wheel 103, an axle 107 (as described briefly above) upon which wheel 103 rotates, a motor 111, a motor controller 113, a transmission 115, and a brake 117. As can be seen most clearly in FIG. 10, these components are assembled as a unitary module which can be removed or installed as a unit and each of which is operable independently from the others. By utilizing self-contained modules 109 as such, assembly of vehicle 101 is simplified and the need for advanced mechanical skills (in order to assemble an omni-directional vehicle) is eliminated. In this regard, rather than requiring assembly of a group of complicated, interconnected components, in order to assemble vehicle 101, each module 109 is simply bolted to the frame or body 119 of the vehicle with conventional bolt fasteners. Afterwards, each module is simply plugged into the operator control system and power assembly via, for example, a conventional male/female type interconnector (e.g. each module utilizing only a single connector). Once assembled as such, each module is operably connected to power supply 121 and, furthermore, is controllable to locomote vehicle 101 via operator control module 123. FIG. 10, in this regard, illustrates vehicle 101 as fully assembled as well as illustrates an embodiment of a unique operator control module 123 which will be described in specific detail below. Additionally, FIG. 12 illustrates, in diagrammatic format, one embodiment of a control scheme 125 for vehicle 101 including exemplar vehicle control and power supply communication paths.

In addition to the benefit of ease of installation of control modules 109, such as described above, if there is a failure or malfunction in vehicle 101, most mechanical problems can be corrected by the simple swapping out of an individual omni-directional module using simple tools e.g. again without requiring a high level of mechanical skill. As a result, the need for specialized equipment or tools for maintaining vehicles 101 is minimized as is the need for a highly skilled mechanic or engineering staff.

Turning now to a still further embodiment of the subject invention, in a manner similar to the assembly and repair of vehicles as described above, omni-directional modules 109 can be used to add omni-directional functionality to non-omni-directional vehicles. For example, a set of four omni-directional modules 109 can simply be bolted (e.g. via conventional bolt fasteners) to the appropriate locations on a non-omni-directional vehicle without extensive structural modifications otherwise being required. When connected to an operator control module (of the type illustrated in the figures or any other suitable type), then, the converted vehicle is capable of omni-directional mobility.

Turning now again to FIGS. 8 and 9, an example system and method by which vehicle 101 is capable of carrying and unloading munitions is illustrated therein. Generally speaking, in this embodiment, munitions tray 127 is provided for carrying a munition on vehicle 101 (or other load types as desired) such as for transport to or from an aircraft. Additionally, because the sensitive nature of munitions typically requires that they be handled with considerable care, the ability to securely fasten a munition to munitions tray 127 (and thus to vehicle 101) is provided by at least one embodiment of the subject invention. In one such embodiment, it is possible to bolt (or otherwise fasten) a munition (or other load type) to munitions tray 127 which, in turn, is fastened to vehicle 101 in a manner conventional in the art or as specifically adapted for a specific munitions tray configuration.

In certain military applications, such as on a Navy aircraft carrier, it is additionally beneficial for a munitions carrying vehicle to possess load ejection capabilities. Therefore, although embodiments in which such ejection capabilities are not present are, of course, envisioned, vehicle 101, as illustrated in FIGS. 8 and 9, is shown with an ejection system capable of ejecting a vehicle load such as when desired by a vehicle operator. In this regard, in the illustrated embodiment, vehicle 101 is equipped with a tray mount 129 for carrying munitions tray 127 and to which tray 127 can be selectively fastened and unfastened (or locked and unlocked, for example). In order to provide such capabilities, a tray locking system is provided in more preferred embodiments of the subject invention (as will be described immediately below).

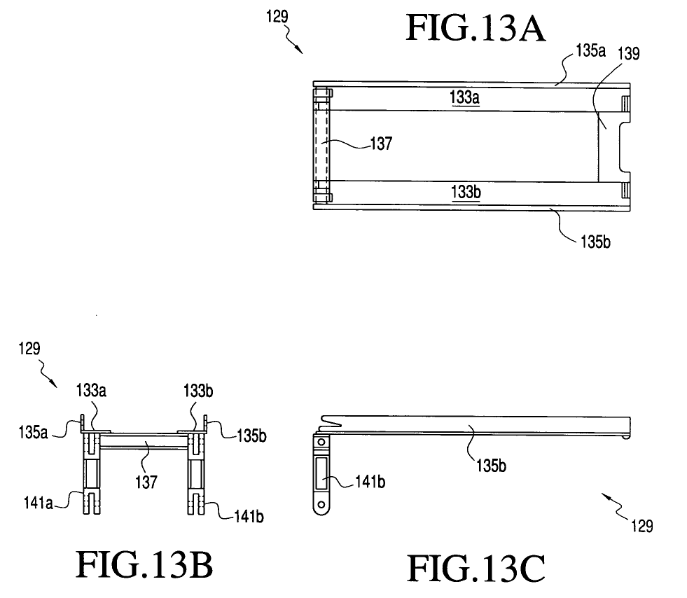

Referring now to FIGS. 13-15, a detailed view of a particularly efficacious embodiment of a tray locking device (for locking tray 127 to mount 129) and load ejection system is shown therein. FIG. 13, as depicting such an embodiment, illustrates tray mount 129 as comprising a pair of L-shaped rails 131a and 131b located oriented opposite one another in a parallel configuration. Oriented and configured as such, each rail 131a-b includes a tray carrying surface 133a and 133b as well as a tray guide surface 135a and 135b (e.g. for guiding tray 127 as it is ejected from vehicle 101). Each rail, in turn, is rigidly fastened to the opposite rail via cross-members 137 and 139 for maintaining the locational relationship of the rails with respect to each other. Additionally connected to each rail are pivot arms 141a and 141b, respectively, for connecting tray mount 129 to vehicle body 119. In preferred embodiments, pivot arms 141a-b extend downwardly substantially vertically from one end of tray mount 129 and are configured for pivotally connecting tray mount 129 to vehicle 101 (i.e. so that the tray mount can be tilted during an ejection operation).

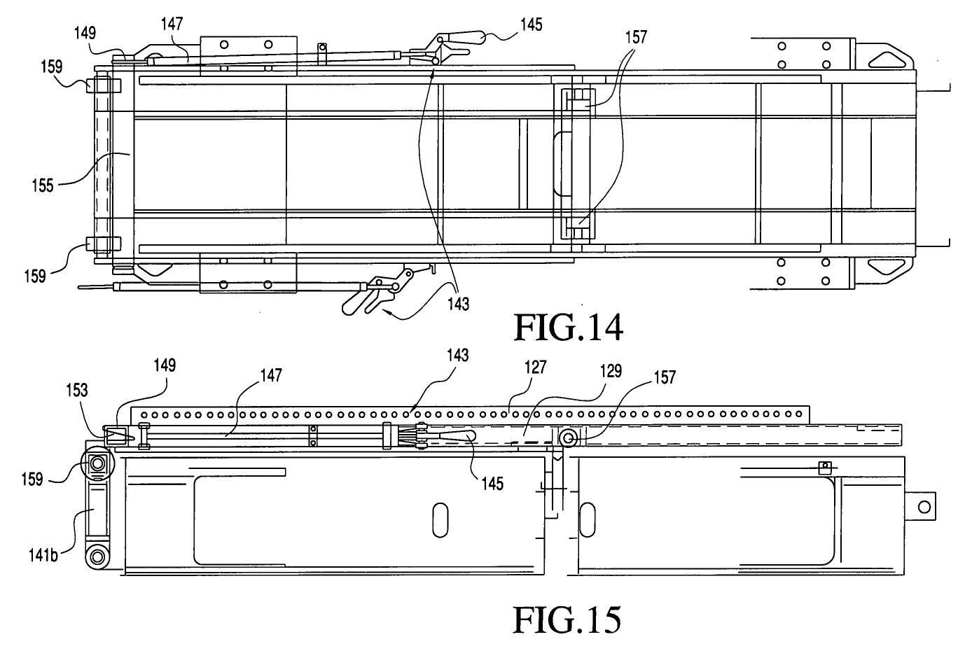

Provided for locking and unlocking tray 127 to tray mount 129, ejection mechanism 143, illustrated in detail in FIGS. 14 and 15, generally comprises a manually operable lever 145 and a locking arm 147. More specifically, locking arm 147 includes a latch member 149 (e.g. a u-bolt) at one end thereof for selectively engaging and biasing locking member 151 against or within locking groove 153 (e.g. connected to or part of tray mount 129). As may be seen in the figures, locking member 151, in the illustrated embodiment, is simply a cross-member (e.g. member 155) extending between the longitudinal rails of tray 127. When constructed as such, locking arm 147, via its (preferably) pivotable connection to mount 129, can be swung into a locking position such that latch member 149 engages an end thereof and can be operated, via lever 145 (pivotally attached to mount 129), to securely bias member 155 into the recessed area of locking groove 153. When biased securely into groove 153 as such, tray 127 is effectively locked to tray mount 129 and can, therefore, safely and securely carry munition loads, for example. Conversely, in order to “unlock” tray 127 from mount 129, lever 145 can be operated in an opposite direction (e.g. into an “open” position) to release the biasing pressure of latch 149 against member 155. When the lever is operated as such, member 155 is no longer secured (i.e. biased) to (or within) groove 153 and tray 127 is therefore unlocked from the vehicle/tray mount 129 (e.g. for a load ejection operation).

In some embodiments of the subject invention, in order to facilitate ease of ejection of loads from vehicle 101, low friction surfaces and/or wheels are included on appropriate surfaces of tray 127 and/or tray mount 129 e.g. so that tray 127 can be more easily moved across the carrying surface of mount rails 131a-b. Referring now, again, to FIGS. 14 and 15, a preferred embodiment of an ejection system employing two pairs of wheels for such purpose is illustrated therein. In such an embodiment, as can be seen in the subject figures, tray 127 includes a pair of tray wheels 157 so located so as to engage tray carrying surfaces 133a and 133b when the tray is in an eject ready position. Additionally, tray mount 129 includes a pair of mount wheels 159 which are located and configured to contact the undersurface of munitions tray 127 during an ejection operation. Therefore, employing this configuration, when lever 145 is in an open or unlocked position and tray 127 is located in a position ready for ejection, the wheel-to-tray and wheel-to-mount surface contacts, as described above, permit tray 127 to move with minimal friction or resistance along the surface of tray mount 129 e.g. to facilitate ejection of tray 127 from vehicle 101.

Conversely, when tray 127 is in a locked position, the illustrated embodiment of the ejection system is so designed such that wheels 157 and 159 are removed from contact with the traveling surfaces of tray 127 and tray carrying surfaces 133a and 133b, respectively. More specifically, in the locked position, tray 127 is located rearward of wheels 159, and wheels 157 are located rearward of tray mount 129 (see FIG. 15). When the wheels are located in such positions, there is direct contact between the non-wheeled surfaces of tray 127 and tray mount 129 (e.g. metal to metal contact). This, in effect, provides substantial movement resistance to tray 127 such resitance assisting in the locking of the tray to vehicle 101 (e.g. in combination with the above described locking mechanism). Moreover, in a particularly preferred embodiment, locking mechanism 143 is so designed such that when lever 145 is advanced to the eject position (e.g. in the opposte direction), tray 127 is advanced in a forward direction along the surface of tray mount 129 (as well as to a slight elevation) such that tray 127 moves into the wheel-engaged-position described above.

Referring now again to FIG. 10, an example of a particularly preferred embodiment of an operator control module 123 for controlling the directional movement of vehicle 101 is illustrated therein. As can be seen in the subject figure, control module 123 is operably connected to vehicle 101 via an operator boom structure 181 constructed from the pivotable connections of first, second, and third arms 183, 185, and 187 respectively. In such an embodiment, the respective arms are so configured and so connected one to the other, such that a desired angular orientation of control module 123 can be maintained as the vehicle is operated from one location to another (as well as during turning, etc.). In particular, such a feature benefits a user who desires, for example, to remain “facing” along the longitudinal axis of the vehicle regardless of which direction the vehicle is operated e.g. for safety purposes or for operator comfort. Although preferred embodiments of such a control mechanism maintain alignment of control module 123 with the longitudinal axis of the vehicle, various other angles with respect to such axis may, of course, be selected depending on field conditions or operator preferences, for example. However, regardless of the angle selected, the embodiment of the control mechanism illustrated in FIG. 10 permits such angle to be maintained indefinitely, as desired (or within specific tolerances). A more detailed description of such control mechanisms (as well as additional variations thereof) is contained in a co-pending patent application, similarly invented, and co-owned by Airtrax, Inc.

While various embodiments of the present invention have been described above and in the drawings, it should be understood that they have been presented only as examples, and not as limitations. Furthermore, once given the above disclosure, many other features, modifications, and improvements will become apparent to the skilled artisan. Such other features, modifications, and improvements are therefore considered to be part of this invention, the scope of which is to be determined by the following claims:

1. A munitions handling vehicle adapted for loading and unloading munitions on and from military aircraft, said munitions handling vehicle comprising:
(a) a vehicle chassis;
(b) a plurality of omni wheels mounted on respective wheel axles and cooperating to induce omni-directional movement of said vehicle;
(d) a munitions carrier supported by said vehicle chassis for carrying munition loads, said munitions carrier being movable upon actuation of a lift between a weapons-transport position and an aircraft-access position, such that:
i. in said weapons-transport position, said lift is sufficiently retracted adjacent said vehicle chassis to facilitate transport of weapons in said carrier to and from the aircraft; and
ii. in said aircraft-access position, said lift is sufficiently extended to enable precision loading and unloading of weapons in the aircraft without repositioning or reconfiguring the aircraft.

2. A munitions handling vehicle according to claim 1, wherein each of said omni wheels comprises a plurality of generally elliptical-shaped rollers.

3. A munitions handling vehicle according to claim 2, wherein each of said omni wheels comprises at least six of said rollers.

4. A munitions handling vehicle according to claim 1, and comprising an electric motor operatively connected to each of said omni wheels for actuating said wheels.

5. A munitions handling vehicle according to claim 4, wherein each electric motor is capable of generating at least five horsepower.

6. A munitions handling vehicle according to claim 1, wherein said lift comprises a scissor lift including a plurality of cooperating, interconnected, crossing arms.

7. A munitions handling vehicle according to claim 1, wherein said lift comprises a collapsible munitions stand including a plurality of cooperating, interconnected, folding arms.

8. A munitions handling vehicle according to claim 1, wherein said vehicle chassis comprises a support platform.

9. A munitions handling vehicle according to claim 1, wherein said vehicle defines a profile measured from an uppermost extremity of said vehicle to a ground surface, said profile being less than 14 inches when said mechanical lift is fully retracted.

10. A munitions handling vehicle according to claim 1, wherein said vehicle defines a maximum reach measured from said munitions carrier to a ground surface, said maximum reach being greater than 60 inches when said mechanical lift is fully extended.

11. A munitions handling vehicle adapted for loading and unloading weapons in military aircraft, said munitions handling vehicle comprising:
(a) a vehicle chassis;
(b) a plurality of wheel axles attached to said vehicle chassis;
(c) a plurality of omni wheels mounted on respective wheel axles and cooperating to induce omni-directional movement of said vehicle;
(d) a mechanical lift supported by said vehicle chassis; and
(e) a munitions carrier secured to a top end of said lift, and movable upon actuation of said lift between a weapons-transport position and an aircraft-access position, such that:
i. in the weapons-transport position, said lift is sufficiently retracted adjacent said vehicle chassis to facilitate transport of weapons in said carrier to and from the aircraft; and
ii. in the aircraft-access position, said lift is sufficiently extended to enable precision loading and unloading of weapons in the aircraft without repositioning or reconfiguring the aircraft; and
(f) said munitions handling vehicle defining a profile measured from an uppermost extremity of said vehicle to a ground surface, said profile being less than 14 inches when said mechanical lift is fully retracted.

12. A munitions handling vehicle adapted for loading and unloading weapons in military aircraft, said munitions handling vehicle comprising:
(a) a vehicle chassis;
(b) a plurality of wheel axles attached to said vehicle chassis;
(c) a plurality of omni wheels mounted on respective wheel axles and cooperating to induce omni-directional movement of said vehicle;
(d) a mechanical lift supported by said vehicle chassis; and
(e) a munitions carrier secured to a top end of said lift, and movable upon actuation of said lift between a weapons-transport position and an aircraft-access position, such that:
i. in the weapons-transport position, said lift is sufficiently retracted adjacent said vehicle chassis to facilitate transport of weapons in said carrier to and from the aircraft, and in the weapons-transport position, said vehicle defines a profile of less than 14 inches measured from an uppermost extremity of said vehicle to a ground surface; and
ii. in the aircraft-access position, said lift is sufficiently extended to enable precision loading and unloading of weapons in the aircraft without repositioning or reconfiguring the aircraft, and in the aircraft-access position, said vehicle defines a maximum reach of greater than 60 inches measured from said munitions carrier to the ground surface.

13. A munitions handling vehicle according to claim 12, wherein each of said omni wheels comprises a plurality of generally elliptical-shaped rollers.

14. A munitions handling vehicle according to claim 13, wherein each of said omni wheels comprises at least six of said rollers.

15. A munitions handling vehicle according to claim 12, and comprising an electric motor operatively connected to each of said omni wheels for actuating said wheels.

16. A munitions handling vehicle according to claim 15, wherein each electric motor comprises a minimum of 5 horsepower.

17. A munitions handling vehicle according to claim 12, wherein said mechanical lift comprises a scissor lift including a plurality of cooperating, interconnected, crossing arms.

18. A munitions handling vehicle according to claim 12, wherein said mechanical lift comprises a collapsible weapons stand including a plurality of cooperating, interconnected, folding arms.

19. A munitions handling vehicle according to claim 12, wherein said vehicle chassis comprises a support platform.

20. A method for loading weapons in military aircraft, comprising the steps of:
(a) transporting a weapon to an aircraft on a munitions handling vehicle, the vehicle comprising a plurality of omni wheels cooperating to induce omni-directional movement of the vehicle;
(b) with the vehicle located at the aircraft, moving the weapon from a weapons transport position, wherein the vehicle defines a profile of less than 14 inches measured from an uppermost extremity of the vehicle to a ground surface, to an aircraft-access position, wherein the vehicle defines a maximum reach of greater than 60 inches measured from the ground surface; and
(c) in the aircraft-access position, loading the weapon in the aircraft.
